(19) United States
(12) Patent Application Publication
(10) Pub. No.: US 2010/0310811 A1
(43) Pub. Date: Dec. 9, 2010

(54) SINGLE-LAYER PLASTIC COMPOSITE PANEL

(76) Inventor: Luhao Leng, Fujian (CN)

Correspondence Address: RABIN & Berdo, PC, 1101 14TH STREET, NW, SUITE 500, WASHINGTON, DC, 20005, US

(21) Appl. No.: 12/664,489

(22) PCT Filed: Dec. 31, 2008
(86) PCT No.: PCT/CN2008/073913

§ 371 Date: Dec. 14, 2009

(30) Foreign Application Priority Data
Feb. 25, 2008 (CN) 200810070682.8

(51) Int. Cl. B32B 3/02; B32B 3/00; B32B 1/04; B32B 3/30; B32B 3/10

(52) U.S. Cl. 428/76; 428/189; 428/157; 428/174; 428/138

(57) ABSTRACT

A single-layer plastic composite panel (10) includes a single plastic panel (11), an injection molding plastic element (12) whose periphery is bonded or welded with that of panel (11), and a strengthener injection molding plastic element (12), by ultrasonic welding or gluing. Said plastic composite panel (10) could be used as table board, chair board and backrest, partition wall of furniture and so on.

### FIELD OF THE INVENTION

The present invention relates to a panel used for making furniture, especially relates to a single-layer composite panel.

### BACKGROUND OF THE INVENTION

Panel is a kind of materials which is used in architecture and manufacturing of furniture, for example, it could be used as decoration board on a wall, table board, teapoy board, chair board and backrest, drawer hoardings, partition wall of bookshelf or cupboard, headboard or footboard of bed, modular furniture board and so on. Just now, owing to the factor of environmental protection, the plastic panel made from plastic is used more and more widely, and it is easy to clean, artistic, and of low cost. There are two types of the plastic panels in use so far. One type is a single-layer plastic panel, which is very heavy, if the thickness is reduced in order to decrease the weight of it, the strength of the plastic panel would be weakened, especially the strength of the edge of plastic panel, and it would be not convenient to connect to other support elements; the other type is a plastic composite panel comprising a plastic face board and a plastic bottom board, in which a strengthener is inserted between the face board and the bottom board. Compared to the single-layer plastic panel, the plastic composite panel requires more material, and the manufacturing process of it is more complex, so there are shortages in the common plastic panels.

### SUMMARY OF THE INVENTION

The main purpose of the present invention is to overcome the shortages of the conventional technique, and provide a single-layer plastic composite panel in which the periphery of a single plastic panel is attached to injection molding plastic elements of different structures by ultrasonic welding or gluing in order to make a composite panel of a single-layer structure. The single-layer plastic composite panel could be used as decoration board on a wall, table board, teapoy board, chair board and backrest, drawer hoardings, partition wall of bookshelf or cupboard, headboard or footboard of bed, modular furniture board and so on. Besides, the structure of the injection molding plastic element could be transformed in order that the single-layer plastic composite panel could be easily connected to other connectors, and the present invention has advantages of high connection strength of edges, low manufacturing cost, easy processing, less weight, less material, easy-to-automated production, and smooth, bright and clean surface of the composite panel.

The technical solution applied by the present invention is:

A single-layer plastic composite panel comprising:

A single plastic panel, made by extrusion molded or vacuum forming after extrusion, is a panel of single-layer structure having a certain size and a certain periphery shape, and the surface of the panel could be curved, flat or of any other shape formed in vacuum forming.

An injection molding plastic element could be a frame structure corresponding to the periphery of the single plastic panel, or a composite structure made of several strip structures or block structures corresponding to the periphery of the single plastic panel, which is made by injection molding.

The injection molding plastic element is attached to the periphery of the single plastic panel by ultrasonic welding or gluing.

Furthermore, the injection molding plastic element also has one or several strip structures connected respectively to the edge of the single plastic panel.

The said strip structures connected to the edge of the single plastic panel are laid out in the said frame structure and form an integral structure together with the said frame structure.

Furthermore, a strengthener is inserted between the single plastic panel and the injection molding plastic element, and is completely covered in the space surrounded by the single plastic panel and the injection molding plastic element.

Furthermore, strengthener is embedded in all or part of the junction of the injection molding plastic element which is connected to the single plastic panel and has a groove used for embedding the strengthener.

The colors of the said single plastic panel and the injection molding plastic element could be same or different.

The edges of the said single plastic panel bend downwards and cover the injection molding plastic element, and a rack set up on the outside of the injection molding plastic element is used to support the end plane of the single plastic panel.

Integral molding slots in which part or all of the edges of the single plastic panel are inserted respectively is set up horizontally or vertically in the injection molding plastic element.

Several convex points or strips, which are set up on the contact end planes of the injection molding plastic element and the plastic single panel, could be melted by ultrasonic welding in order to connect the injection molding plastic element and the plastic single panel together.

An integral molding junction which is bonded to the said injection molding plastic element is used for fixing the injection molding plastic element to the single plastic panel.

The junction of the said injection molding plastic element is a V-shaped component or a component with a hole, and two single-layer plastic composite panels are bonded together with a V-shaped component or a component with a hole.

The top surface of the said single plastic panel also has some printed patterns.

The top surface of said single plastic panel comprises a thin film layer having patterns.

The top surface of the said single plastic panel has the patterns printed by the transfer printing film layer, and thermal curing varnish or light curing varnish is daubed on the patterns.

In the single-layer plastic composite panel of the present invention, the single plastic panel having a certain size and a certain periphery shape is made by extrusion molding or vacuum forming after extrusion is used as the main panel of the single-layer plastic composite panel. An injection molding plastic element made by injection molding which is connected to the periphery of the single plastic panel, and it has two functions: 1. Strengthening the periphery of the composite panel 2. Connecting the composite panel and support structure or doubling plate together. The injection molding plastic element and the single plastic panel are connected together by ultrasonic welding or gluing. If they are connected by ultrasonic welding, in order to satisfy the technological requirement several convex points or strips are set up on the contact end planes of the injection molding plastic element connected to the plastic single panel, and they could be melted by ultrasonic welding so as that the injection molding plastic element and the plastic single panel are wholly or locally welded together. The method of ultrasonic welding is that the vibration of high frequency of the welding machine makes the surfaces of the injection molding plastic element and the plastic single panel rub together and makes the molecules in them rub together, so that temperature of the junction rises, and when it reaches the melting point of plastic, the convex points or strips on the junction of the injection molding plastic element and the plastic single panel melt soon and bind them together. Then the vibration stops and under a certain pressure, the injection molding plastic element and the plastic single panel is cooled and shaped, so that they are welded together and form a single-layer plastic composite panel.

In the single-layer plastic composite panel of the present invention, the single plastic panel is extrusion molding panel, whose surface shape and size is molded according to the practical requirement, it is not like the plastic element that needs expensive equipments and molds. Besides, the surface of it made by integral molding is smooth, multicolor, and it has no shrinkages, flow marks and other defects. The single plastic panel made by vacuum forming or direct forming is of single-layer structure. The surface of the single plastic panel could be shaped curved, plat or of any other shapes formed in vacuum forming, which make products in the present invention diverse and applicable in a wide range. According to different practical requirements, patterns could be printed on the top surface of the single plastic panel, or a thin film layer having patterns could be set up on the top surface of the single plastic panel, for example, colors of different wood grain, marble and other natural materials could be printed the top surface of the single plastic panel, or a thin film layer having colors of different wood grain, marble and other natural materials could also be set up on the top surface of the single plastic panel. Patterns could also be transfer printed on the top surface of the single plastic panel with a transfer printing film, for example, the transfer printing film having colors of different wood grain, marble and other natural materials on the top surface of the single plastic panel transfer prints the colors on it, and then the film is removed and thermal curing varnish or light curing varnish is daubed on the top surface of the single plastic panel in order to increase the hardness and the weathering resistance of the top surface.

In the single-layer plastic composite panel of the present invention, an interior strengthener and an exterior strengthener are laid out. The interior strengthener is completely covered in the space surrounded by the single plastic panel and the injection molding plastic element, and the exterior strengthener is inserted in the corresponding injection molding plastic element with grooves, which raise the strength of the periphery of the single-layer plastic composite panel.

In the single-layer plastic composite panel of the present invention, the injection molding plastic element could be a frame structure or a H-shaped structure made by injection molding, and it could also be a composite structure made up of several strip structures or block structures. Because the injection molding plastic element is made up of multiple components, the size of the plastic components could be small and the problem of large injection molding plastic element could be avoided in order to lower the cost of the equipments and moulds.

A single plastic panel, which is made by extrusion molding or vacuum forming after extrusion and has a certain size and a certain periphery shape, is used as the main panel of the single-layer plastic composite panel. An injection molding plastic element is bonded with the periphery of the plastic panel by ultrasonic welding or gluing. The single-layer plastic composite panel could be used as decoration board on a wall, table board, teapoy board, chair board and backrest, drawer hoardings, partition wall of bookshelf or cupboard, headboard or footboard of bed, modular furniture board and so on. Besides, the structure of the injection molding plastic element could be transformed in order that the single-layer plastic composite panel could be easily connected to other connectors, and the present invention has advantages of high connection strength of edge, low manufacturing cost, easy processing, less weight, less material, easy-to-automated production, and smooth, bright and clean surface of the composite panel.

The present invention is described in the following drawings and embodiments, but the present invention is not limited in these embodiments.

### BRIEF DESCRIPTION OF THE DRAWINGS

FIG. 1 is a three-dimension view of the single-layer plastic composite panel in embodiment 1.

FIG. 2 is a three-dimension exploded view of the single-layer plastic composite panel in embodiment 1.

FIG. 3 is a sectional view of the periphery of the single-layer plastic composite panel.

FIG. 4 is a three-dimension view of the single-layer plastic composite panel in embodiment 2.

FIG. 5 is a three-dimension exploded view of the single-layer plastic composite panel in embodiment 2.

FIG. 6 is a partial view of the single-layer plastic composite panel in embodiment 3.

FIG. 7 is a structure view of the single-layer plastic composite panel used as a functional board in embodiment 3.

FIG. 8 is a top view of the single-layer plastic composite panel used as a functional board in embodiment 3.

FIG. 9 is a partial view of the single-layer plastic composite panel in embodiment 4.

FIG. 10 is a structure view of the single-layer plastic composite panel used as a table board in embodiment 4.

FIG. 11 is a top view of the single-layer plastic composite panel used as a table board in embodiment 4.

FIG. 12 is a partial view of the single-layer plastic composite panel in embodiment 5.

FIG. 13 is a structure view of the single-layer plastic composite panel used as a chair board and backrest in embodiment 5.

FIG. 14 is a schematic diagram of the single-layer plastic composite panel used in chair in embodiment 5.

FIG. 15 is a structure view of the single-layer plastic composite panel used as a chair board and backrest in embodiment 6.

FIG. 16 is a schematic diagram of the single-layer plastic composite panel used in chair in embodiment 6.

FIG. 17 is a partial view of the single-layer plastic composite panel in embodiment 7.

FIG. 18 is a partial view of the single-layer plastic composite panel in embodiment 8.

FIG. 19 is a schematic diagram of the single-layer plastic composite panel used as drawer hoardings in embodiment 8.

FIG. 20 is an expanded diagram of the structure of the drawer hoardings in embodiment 8.

FIG. 21 is an expanded diagram of the structure of the drawer hoardings in embodiment 9.

FIG. 22 is an enlarged view of part C in FIG. 21.

FIG. 23 is a partial view of the single-layer plastic composite panel in embodiment 10.

FIG. 24 is a partial diagram of the single-layer plastic composite panel used as a partition wall in embodiment 10.

FIG. 25 is a top view of the single-layer plastic composite panel used as a partition wall in embodiment 10

FIG. 26 is a partial diagram of the single-layer plastic composite panel used as a partition wall in embodiment 11.

FIG. 27 is a partial diagram of the single-layer plastic composite panel used as a partition wall in embodiment 12.

FIG. 28 is schematic diagram of the single-layer plastic composite panel in embodiment 13.

FIG. 29 is a sectional view of the A-A line in FIG. 28.

FIG. 30 is a sectional view of the B-B line in FIG. 28.

FIG. 31 is a connection diagram when the single-layer plastic composite panel is used as modular furniture board in embodiment 13.

FIG. 32 is an enlarged view of part D in FIG. 21.

### DESCRIPTION OF SPECIFIC EMBODIMENTS

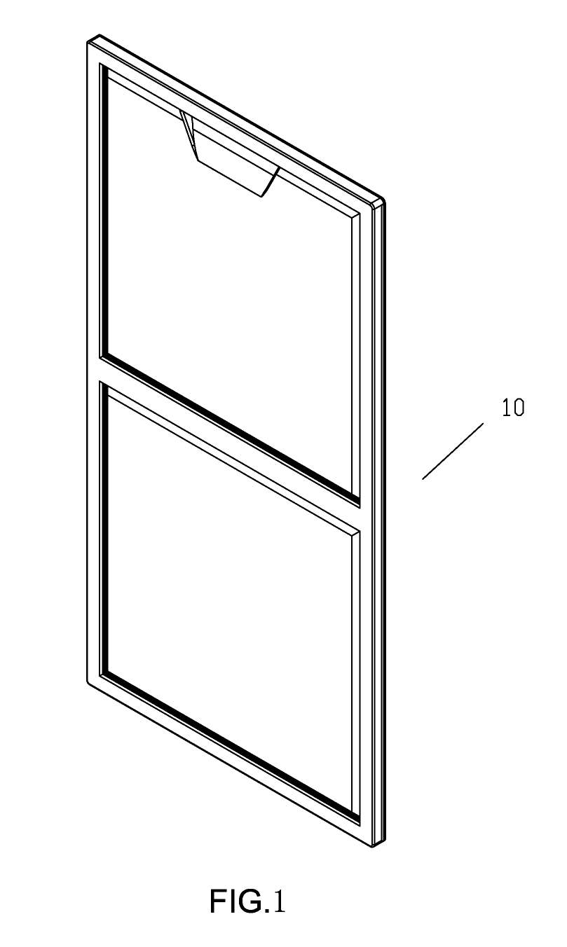

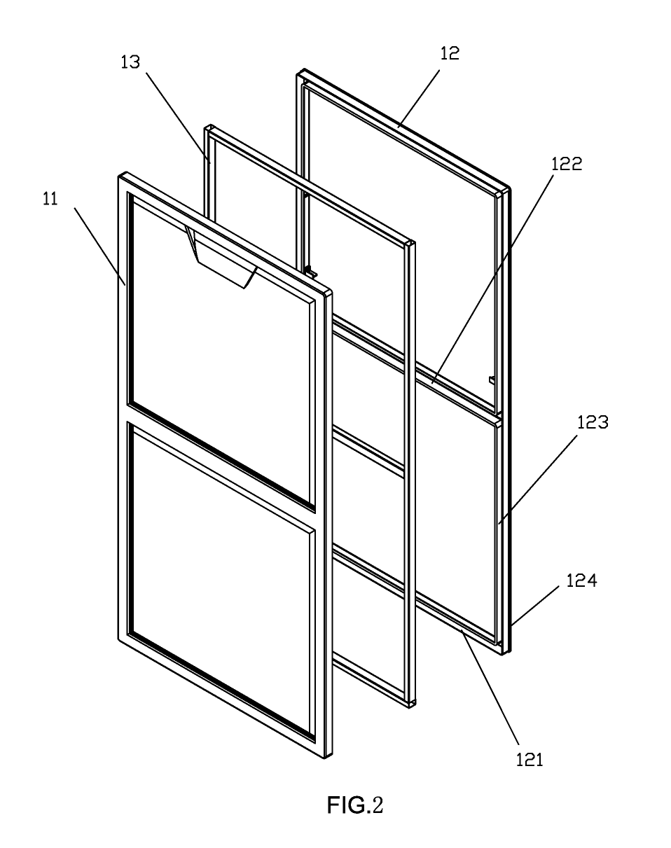

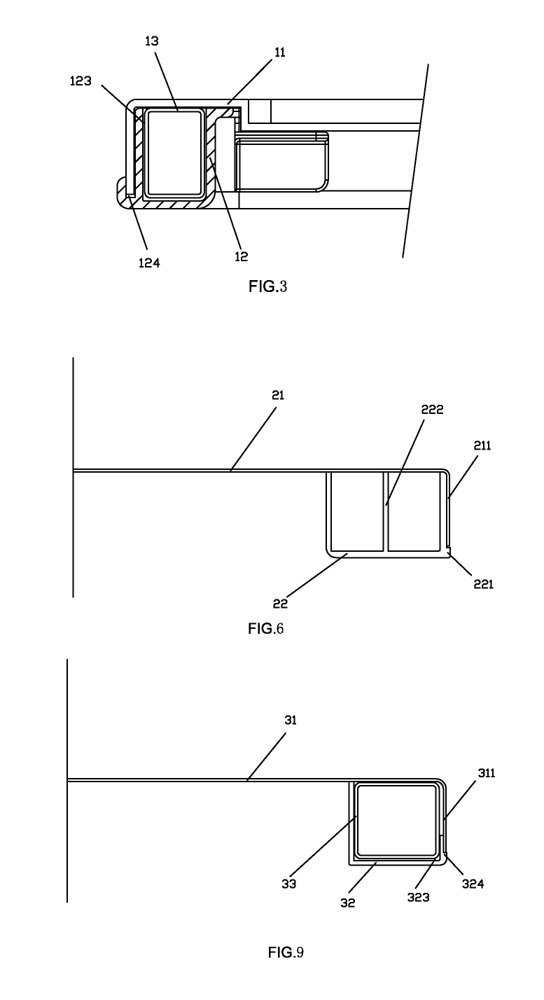

In embodiment 1of the present invention, referring to FIG. 1, FIG. 2 and FIG. 3, the single-layer plastic composite panel is used as a side plate 10, which comprising:

A single plastic panel 11, made by extrusion molded or vacuum forming after extrusion, is a panel of single-layer structure having a certain size and a certain periphery shape, and the surface of the panel is shaped by vacuum forming, which has two concavities in order to assemble with the injection molding plastic element having a [symbol] -shaped frame.

An injection molding plastic element 12 comprises a direct-molding frame structure 121 corresponding to the periphery of the single plastic panel and a strip structure 122 formed in the frame structure. The frame structure 121 and the strip structure 122 are made into an integral body by injection molding, and the injection molding plastic element 12 has grooves 123 which the interior strengthener could insert in order to facilitate assembly. Meanwhile, slots 124 are set up in two opposite edges respectively in order that the single plastic panel 11 could insert in it and facilitate the connection between the injection molding plastic element 12 and the single plastic panel 11.

A interior strengthener 13, embedded in the [symbol] -shaped junction of the injection molding plastic element 12 and the single plastic panel 11, is in the shape of [symbol] .

The injection molding plastic element 12 and the single plastic panel 11 connected together by ultrasonic welding or gluing, and the frame structure 121 of the injection molding plastic element 12 is bonded with the periphery of the single plastic panel 11. The edges of the single plastic panel 11 bend downwards and cover the injection molding plastic element, and the two opposite edges of the single plastic panel 11 respectively insert in the slots in two opposite edges of the injection molding plastic element 12. The exterior strengthener 13 is completely covered in the space surrounded by the injection molding plastic element 12 and the single plastic panel 11.

the color of the single plastic panel 11 and the color of the injection molding plastic element 12 could be same or different; different patterns could be printed on the top surface of the single plastic panel 11; a film layer having patterns could be set up on the top surface of the single plastic panel 11; the patterns could also be transfer printed on the top surface of the single plastic panel 11 by a transfer printing film layer, and thermal curing varnish or light curing varnish is daubed on the patterns.

In the embodiment 2 of the present invention, referring to FIG. 4 and FIG. 5, the single-layer plastic composite panel is also used as a side plate 10, compared to the embodiment 1, the surface of single plastic panel 11 is different.

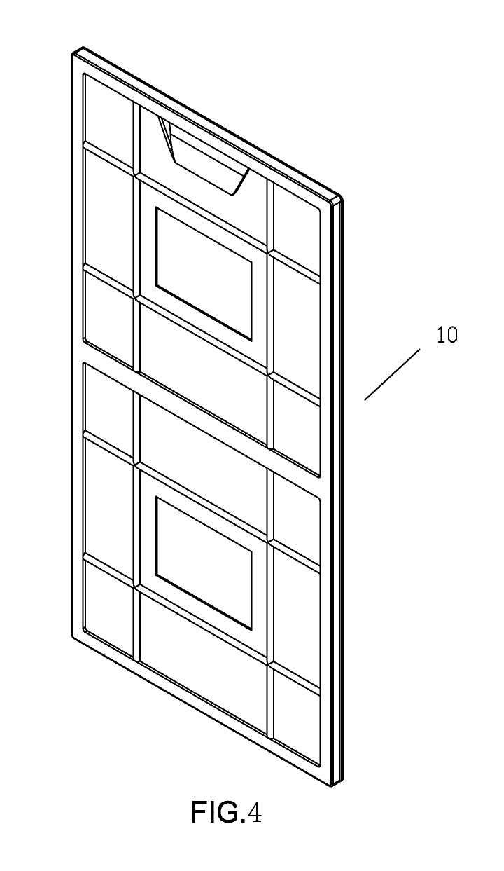

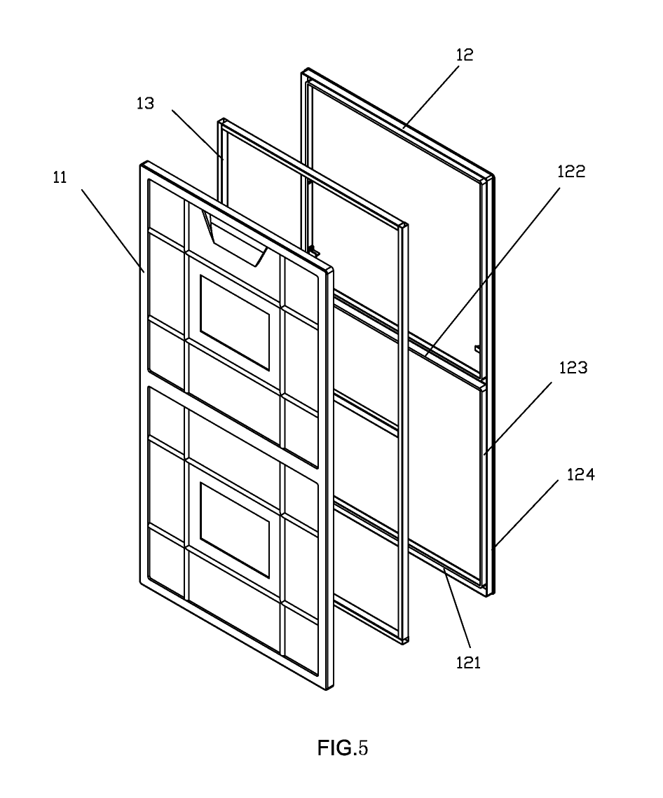

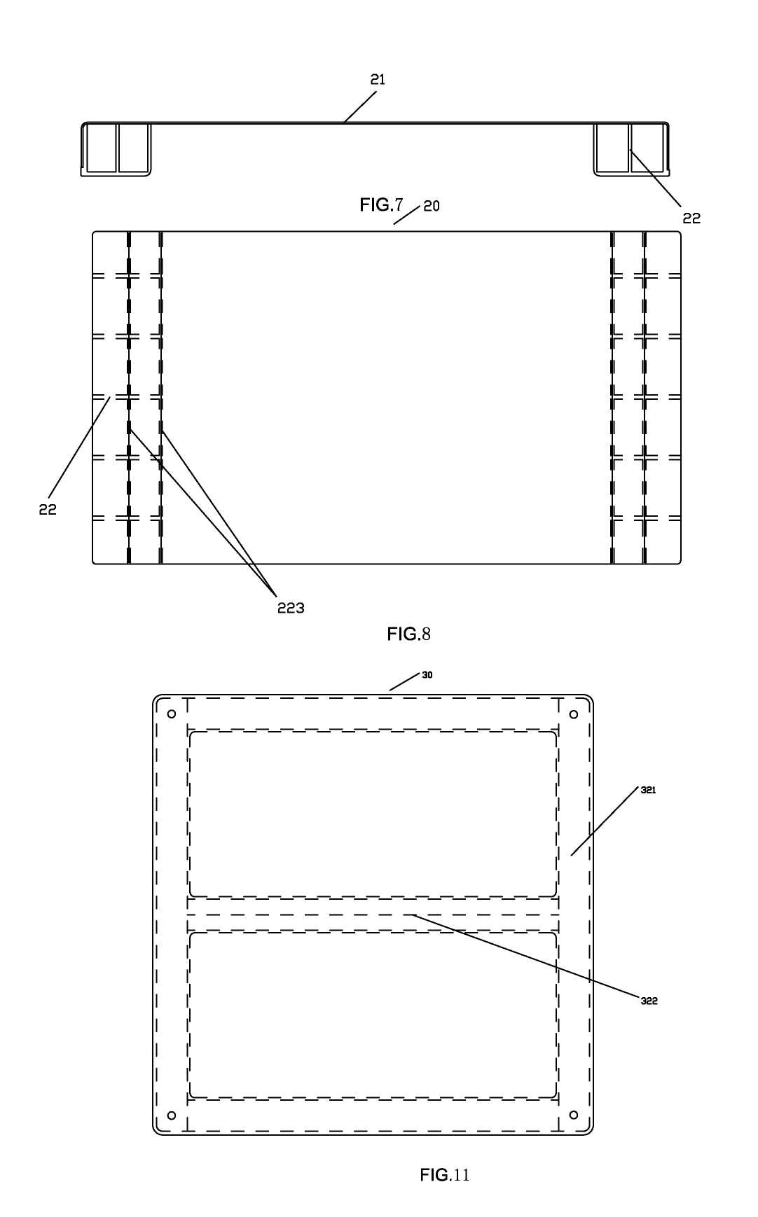

In the embodiment 3 of the present invention, referring to FIG. 6, FIG. 7 and FIG. 8, the single-layer plastic composite panel is used as a functional board 20, which comprising:

A single plastic panel 21, made by extrusion molded or vacuum forming after extrusion, is a panel of single-layer structure having a certain size and a certain periphery shape, and the surface of the panel is flat and the shape of the panel is a rectangle;

An injection molding plastic element 22, made by injection molding, is a composite structure made of two strip structures corresponding to the two opposite edges of the single plastic panel 21, and the cross-sections of the two strip structures could be same or different;

The injection molding plastic element 22 is bonded with the two opposite edges of the single plastic panel 21 by ultrasonic welding or gluing.

In the embodiment 3, a bent part 211, which is set up on the periphery of the single plastic panel 21, covers the injection molding plastic element 22 and is bonded with it by ultrasonic welding or gluing in order to make the periphery of the single plastic panel 21 and the injection molding plastic element 22 fixed together; a rack 221 set up on the outside of the injection molding plastic element 22 is used to support the end plane of the single plastic panel 21; several reinforcing ribs 222, which are set up on the injection molding plastic element 22, are used for supporting the single plastic panel 21, and the top surfaces of the reinforcing ribs 222 are in contact with the bottom of the single plastic panel 21 and are bonded with it by ultrasonic welding. Several convex points or strips 223, which are set up on the top surfaces of the reinforcing ribs 222 of the injection molding plastic element, could be melted by ultrasonic welding in order to connect the injection molding plastic element 22 and the plastic single panel 21 together. Without convex points or strips, the top surfaces of the reinforcing ribs 222 could also be bonded with the bottom of the single plastic panel 21 by gluing.

In the embodiment 4 of the present invention, referring to FIG. 9, FIG. 10 and FIG. 11, the single-layer plastic composite panel is used as a table board 30, which comprising:

A single plastic panel 31, made by extrusion molded or vacuum forming after extrusion, is a panel of single-layer structure having a certain size and a certain periphery shape, and the surface of the panel is flat and the shape of the panel is a square;

An injection molding plastic element 32 comprises a direct-molding frame structure 321 corresponding to the periphery of the single plastic panel and a strip structure 322 formed in the frame structure. The frame structure 321 and the strip structure 322 are made into an integral body by injection molding, and the injection molding plastic element 32 has grooves 323 which the interior strengthener could insert in order to facilitate assembly. Meanwhile, racks 324 are set up on the outside of the injection molding plastic element 32 in order to facilitate the connection between the injection molding plastic element 32 and the single plastic panel 31.

A interior strengthener 33, embedded in the [symbol] -shaped junction of the injection molding plastic element 32 and the single plastic panel 11, is in the shape of [symbol] .

The injection molding plastic element 32 and the single plastic panel 321 connected together by ultrasonic welding or gluing, and the frame structure 321 of the injection molding plastic element 32 is bonded with the periphery of the single plastic panel 31. The edges of the single plastic panel 31 bend downwards and cover the injection molding plastic element 32, and the end planes of the periphery of the single plastic panel 31 are in contact with the racks 322 of the injection molding plastic element 32. The exterior strengthener 33 is completely covered in the space surrounded by the injection molding plastic element 32 and the single plastic panel 31.

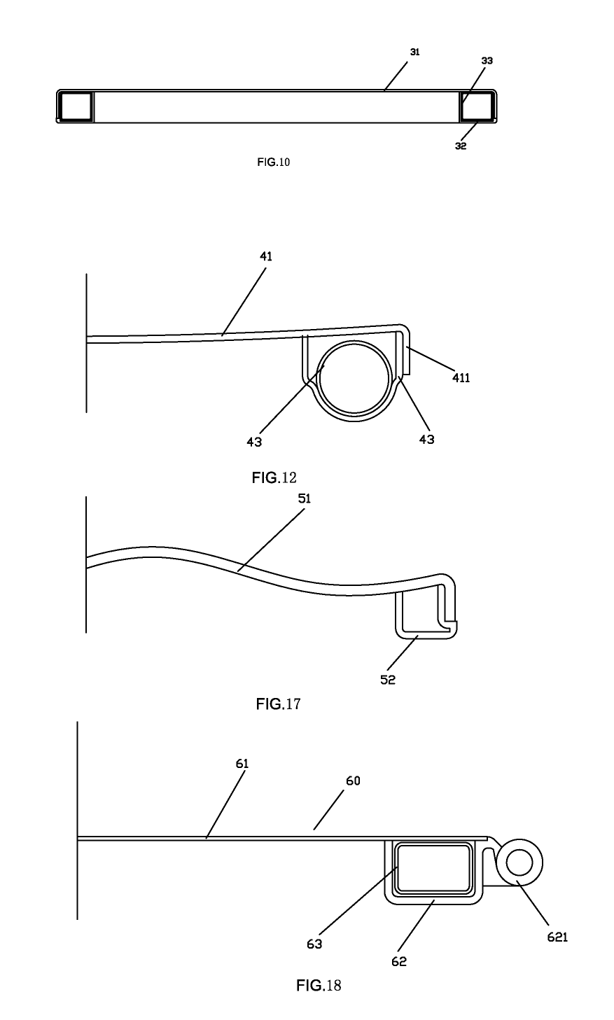

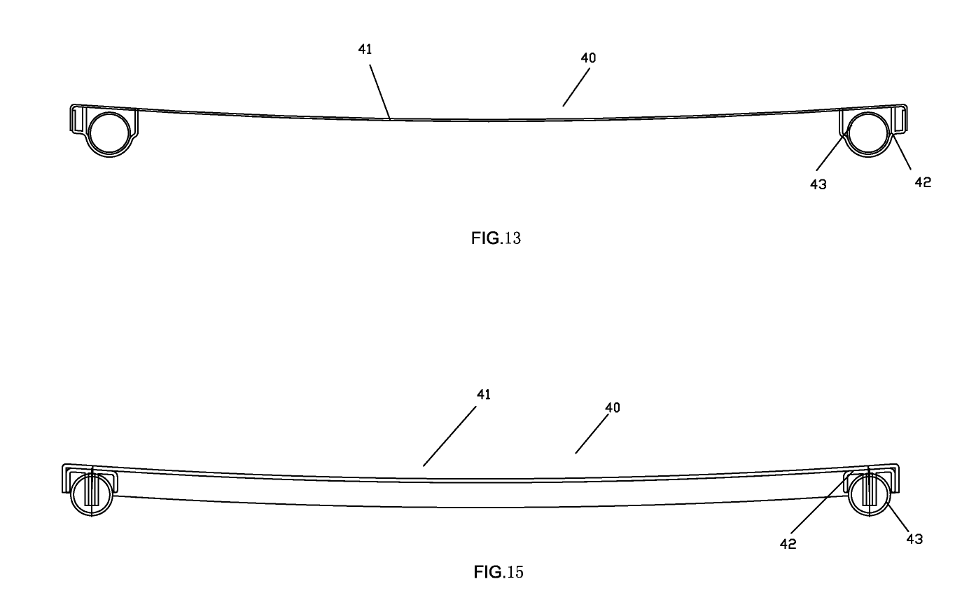

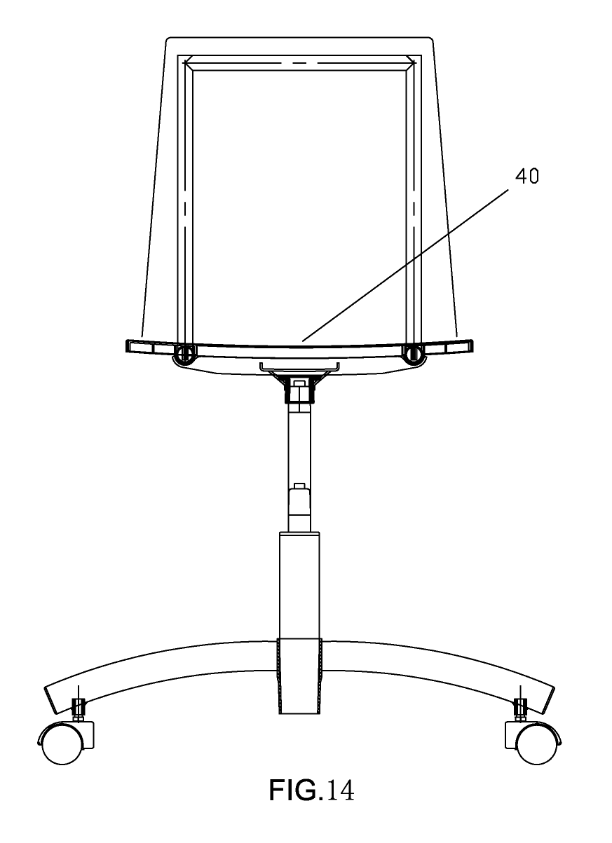

In the embodiment 5 of the present invention, referring to FIG. 12, FIG. 13 and FIG. 14, the single-layer plastic composite panel is used as chair board and backrest, which comprising:

A single plastic panel 41, made by extrusion molded or vacuum forming after extrusion, is a panel of single-layer structure and a certain shape, which has a upper surface and a lower surface;

An injection molding plastic element 42, is several strip structures made by injection molding, and the cross-sections of these strip structures could be same or different;

Part of the periphery of the single plastic panel 41 is bonded with the injection molding plastic element 42 by ultrasonic welding or gluing.

In the embodiment 5, the edge of the single plastic panel 41 bends downwards and forms a bent part 411 which covers the injection molding plastic element 42, and the bent part 411 and the injection molding plastic element 42 are bonded together by ultrasonic welding or gluing. A groove is set up in the injection molding plastic element 42, and the groove mouth faces the direction of connection between the injection molding plastic element 42 and the single plastic panel 41. A pipe 43 which is set up in the groove and is completely covered between the injection molding plastic element 42 and the single plastic panel 41, is used for strengthening the periphery of the composite panel.

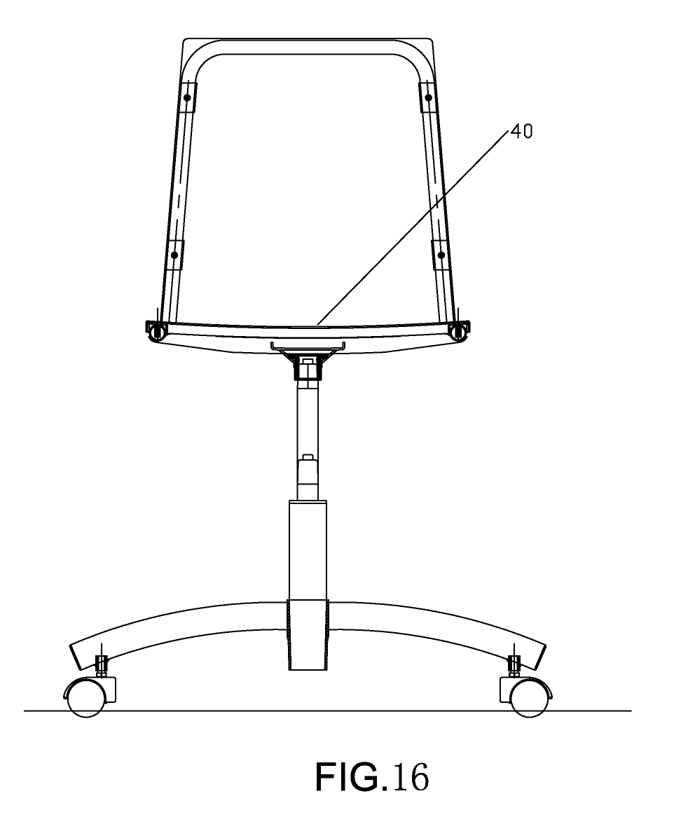

In the embodiment 6 of the present invention, referring to FIG. 15 and FIG. 16, the single-layer plastic composite panel is also used as chair board and backrest, compared to the embodiment 5, the groove mouth faces the opposite direction of connection between the injection molding plastic element 42 and the single plastic panel 41.

In the embodiment 6, a strengthener is inserted in the outside of the corresponding injection molding plastic element 42, which is an exterior strengthener.

In the embodiment 7 of the present invention, referring to FIG. 17, compared to the embodiment 4, in the single-layer plastic composite panel, the surface of the single plastic panel 51 is curved, and no pipe is set up in the groove of the injection molding plastic element 42.

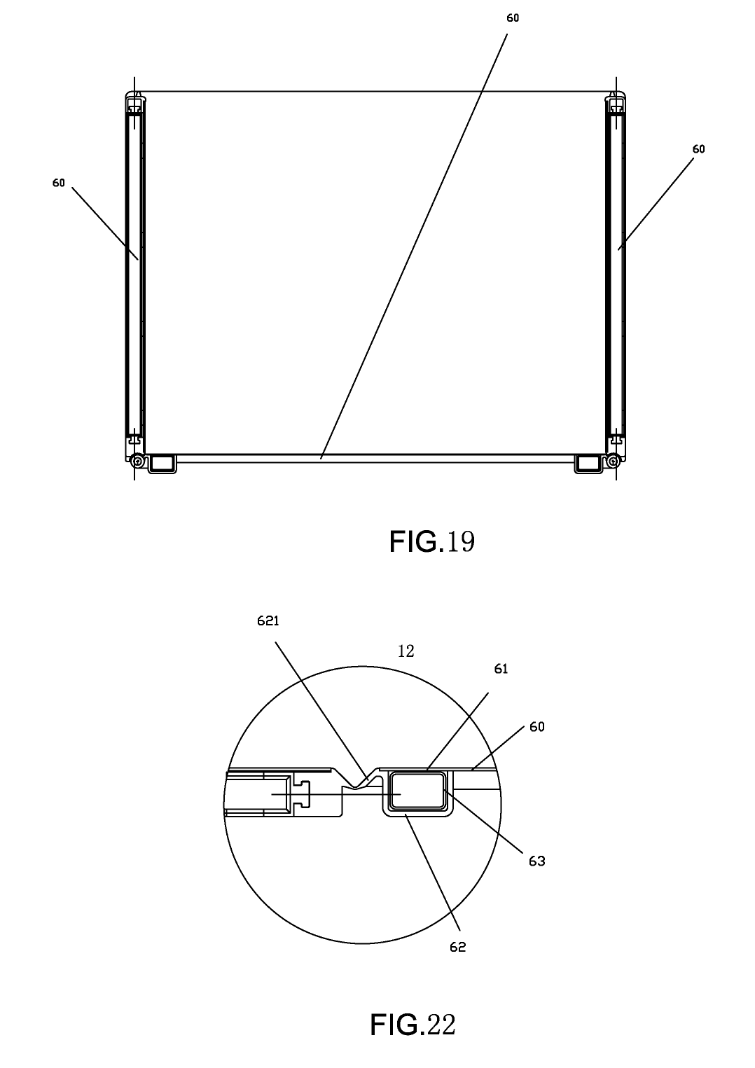

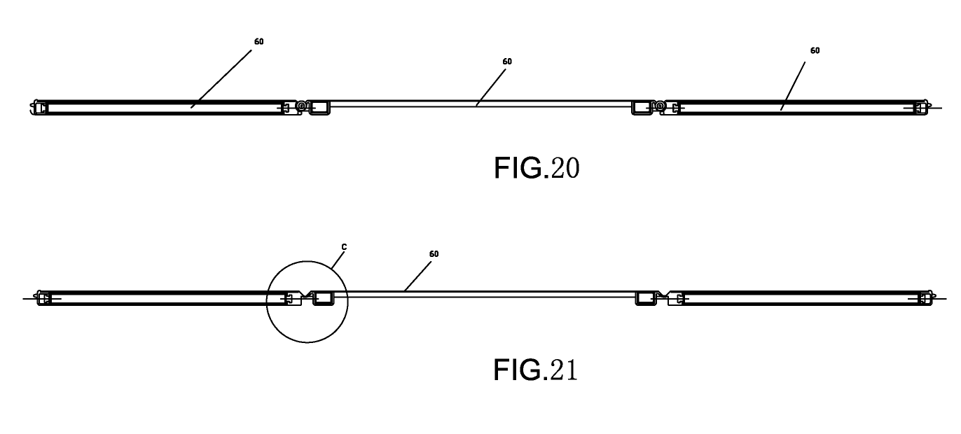

In the embodiment 8 of the present invention, referring to FIG. 18, FIG. 19 and FIG. 20, the single-layer plastic composite panel comprising:

A single plastic panel 61, made by extrusion molded or vacuum forming after extrusion, is a panel of single-layer structure and a certain shape, which has a upper surface and a lower surface;

An injection molding plastic element 62, is several strip structures made by injection molding, and the cross-sections of these strip structures could be same or different;

Part of the periphery of the single plastic panel 61 is bonded with the injection molding plastic element 62 by ultrasonic welding or gluing.

In the embodiment 8, the shape of the single plastic panel 61 is a rectangle, and two opposite edges of the single plastic panel 61 is bonded with the injection molding plastic element 62 by ultrasonic welding or gluing.

A groove is set up in the injection molding plastic element 62 and the groove mouth face the direction of connection between the injection molding plastic element 62 and the single plastic panel 61. A pipe 63 which is set up in the groove and is completely covered between the injection molding plastic element 42 and the single plastic panel 41, is used for strengthening the periphery of the composite panel.

An integral molding junction bonded to the injection molding plastic element 621 is used for fixing the injection molding plastic element to the single plastic panel. The junction 621 of the injection molding plastic element 62 is a component with a hole, and two single-layer plastic composite panels are bonded together with the junction 621.

The type of the single-layer plastic composite panel is suitable to be a drawer hoarding, and five drawer hoardings, which are assembled together with the component 621 with a hole of the injection molding plastic element 62, are foldable.

In the embodiment 9 of the present invention, referring to FIG. 21 and FIG. 22, compared to the embodiment 6, in the single-layer plastic composite panel, the junction of the injection molding plastic element 62 is not a component with a hole, but a thin plastic plate which is used for connecting two injection molding plastic elements, and the injection molding plastic elements 62 are respectively bonded with two different vacuum forming single plastic panels 61, so that the two single plastic panels 61 could fold up.

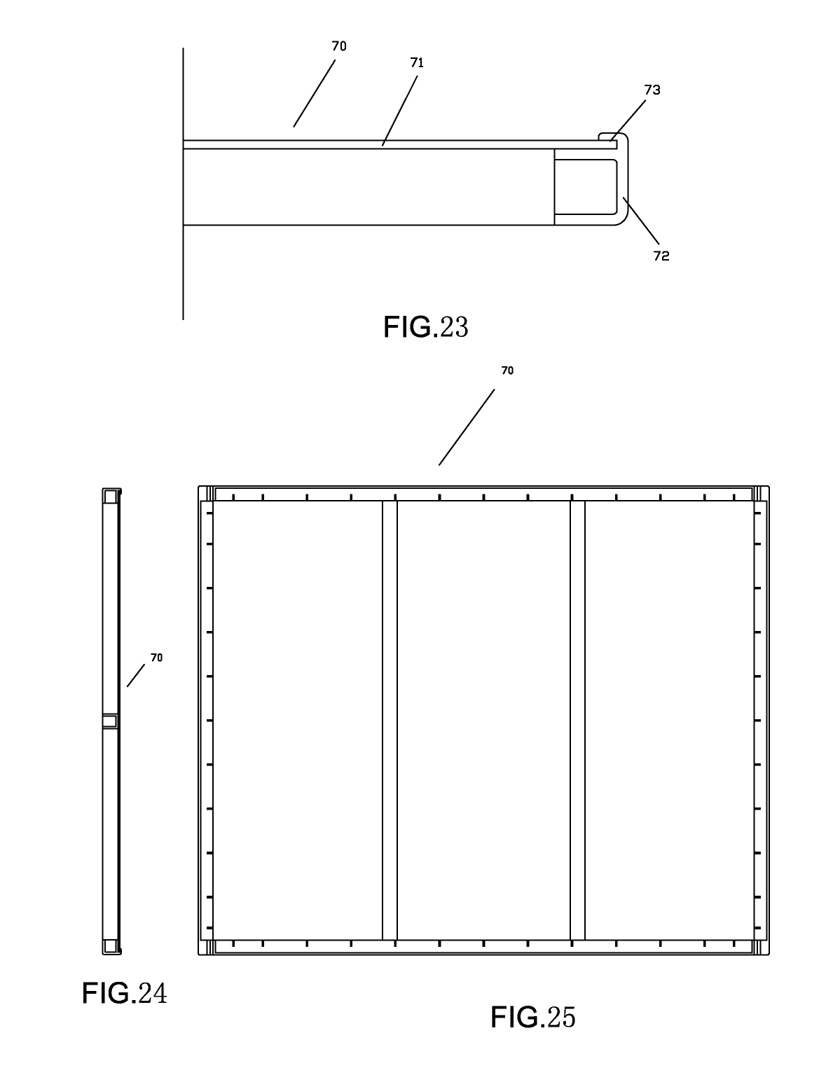

In the embodiment 10of the present invention, referring to FIGS. 23 to 25, the single-layer plastic composite panel comprises a vacuum forming single plastic panel 71, an injection molding plastic element 72 and an integral forming slot 721 in which the edge of the single plastic panel 71 could insert, and the slot 721 is set up horizontally in the injection molding plastic element 72. All or part of the periphery of the single plastic panel 71, which is supported by the injection molding plastic element 72, inserts in the slot 721 of the injection molding plastic element 72 and is bonded with it by gluing.

The type of the single-layer plastic composite panel is suitable to be a partition wall 70 of furniture, referring to FIG. 24 and FIG. 25.

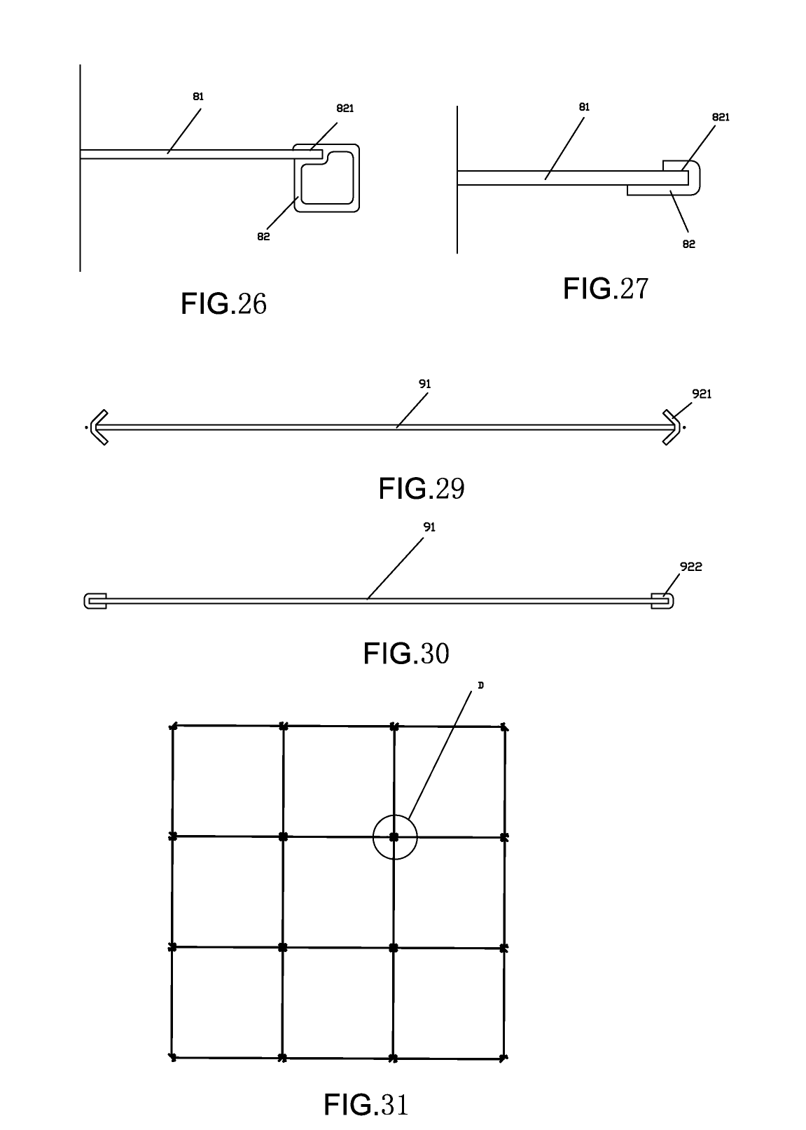

In the embodiment 11of the present invention, referring to FIG. 26, the single-layer plastic composite panel comprises a vacuum forming single plastic panel 81, an injection molding plastic element 82 and an integral forming slot 821 in which the edge of the single plastic pane 181 could insert, and the slot 821 is set up horizontally in the injection molding plastic element 82. All or part of the periphery of the single plastic panel 81, which is supported by the injection molding plastic element 82, inserts in the slot 821 of the injection molding plastic element 82 and is bonded with it by gluing.

In the embodiment 12 of the present invention, referring to FIG. 27, compared to the embodiment 11, in the single-layer plastic composite panel the shape of the injection molding plastic element 82 is different.

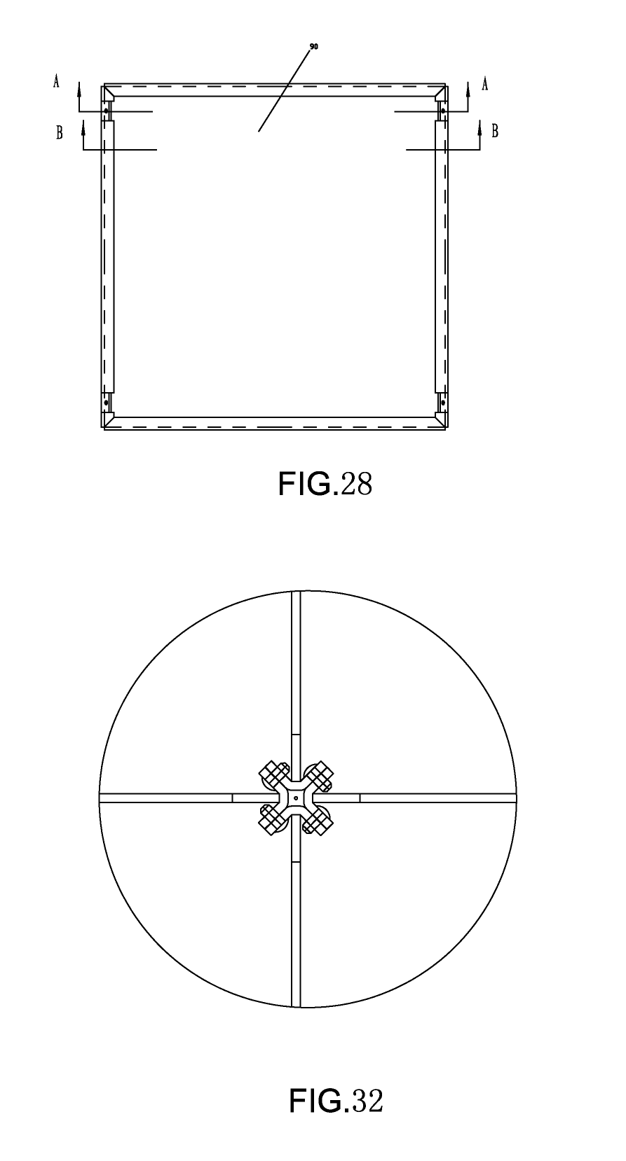

In the embodiment 13 of the present invention, referring to FIG. 28 to 32, the single-layer plastic composite panel is used as a modular furniture board 90, which comprises the single plastic panel 91 and the injection molding plastic element. A single plastic panel 91, made by extrusion molded or vacuum forming after extrusion, is a square panel of single-layer structure having an upper surface and a lower surface; the injection molding plastic element is a strip structure made by injection molding. The injection molding plastic element has two types of its cross-section shapes. One type of the injection molding plastic element 921 has a V-shaped cross-section, while the other type 922 has a U-shaped cross-section. The mouth of the V-shaped cross-section of the injection molding plastic element 921 faces the interior of the single plastic panel 91, and the injection molding plastic element 921 is bonded with the two opposite edges of the single plastic panel 91 by ultrasonic welding or gluing. The mouth of the U-shaped cross-section of the injection molding plastic element 922 faces the interior of the single plastic panel 91 and covers the edges of the single plastic panel 91, and the injection molding plastic element 922 is bonded with the two opposite edges of the single plastic panel 91 by ultrasonic welding or gluing. The modular furniture boards 90 are connected together by the injection molding plastic element 921, and strengthened by the injection molding plastic element 922. So the type of the modular furniture could be assembled without frame.

In the single-layer plastic composite panel of the present invention, a single plastic panel, which is made by extrusion molding or vacuum forming after extrusion and has a certain size and a certain periphery shape, is used as the main panel of the single-layer plastic composite panel. An injection molding plastic element, which is bonded with the periphery of the single plastic panel by ultrasonic welding or gluing, has two functions of strengthening the periphery of the composite panel and connection between the composite panels or between the composite and the support structure. If the injection molding plastic element and the single plastic panel are connected together by ultrasonic welding, in order to satisfy the technological requirement several convex points or strips are set up on the contact end planes of the injection molding plastic element connected to the plastic single panel, and they could be melted by ultrasonic welding so as that the injection molding plastic element and the plastic single panel are wholly or locally welded together. The method of ultrasonic welding is that the vibration of high frequency of the welding machine makes the surfaces of the injection molding plastic element and the plastic single panel rub together and the molecules in them rub together, so that temperature of the junction rises, and when it reaches the melting point of plastic, the convex points or strips on the junction of the injection molding plastic element and the plastic single panel melt soon and bind them together. Then the vibration stops and under a certain pressure, the injection molding plastic element and the plastic single panel is cooled and shaped, so that they are welded together and form a single-layer plastic composite panel.

In the single-layer plastic composite panel of the present invention, the single plastic panel is extrusion molding panel, whose surface shape and size is molded according to the practical requirement, it is not like the plastic element that needs expensive equipments and molds. Besides, the surface of it made by integral molding is smooth, multicolor, and it has no shrinkages, flow marks and other defects. The single plastic panel made by vacuum forming or direct forming is of single-layer structure. The surface of the single plastic panel could be shaped curved, plat or of any other shapes formed in vacuum forming, which make products in the present invention diverse and applicable in a wide range. According to different practical requirements, patterns could be printed on the top surface of the single plastic panel, or a thin film layer having patterns could be set up on the top surface of the single plastic panel, for example, colors of different wood grain, marble and other natural materials could be printed the top surface of the single plastic panel, or a thin film layer having colors of different wood grain, marble and other natural materials could also be set up on the top surface of the single plastic panel. Patterns could also be transfer printed on the top surface of the single plastic panel with a transfer printing film, for example, the transfer printing film having colors of different wood grain, marble and other natural materials on the top surface of the single plastic panel transfer prints the colors on it, and then the film is removed and thermal curing varnish or light curing varnish is daubed on the top surface of the single plastic panel in order to increase the hardness and the weathering resistance of the top surface.

In the single-layer plastic composite panel of the present invention, an interior strengthener and a exterior strengthener are laid out. The interior strengthener is completely covered in the space surrounded by the single plastic panel and the injection molding plastic element, and the exterior strengthener is inserted in the corresponding injection molding plastic element with grooves, which raise the strength of the periphery of the single-layer plastic composite panel.

### INDUSTRIAL APPLICABILITY

In the single-layer plastic composite panel of the present invention, an injection molding plastic element is bonded with the periphery of the plastic panel by ultrasonic welding or gluing. The single-layer plastic composite panel could be easily connected to other connectors, and the present invention has advantages of high connection strength of edge, low manufacturing cost, easy processing, less weight, less material, easy-to-automated production, and smooth, bright and clean surface of the composite panel.

1. A single-layer plastic composite panel comprises:
a single plastic panel, made by extrusion molded or vacuum forming after extrusion, is a panel of single-layer structure having a certain size and a certain periphery shape, and the surface of the panel could be curved, flat or of any other shape formed in vacuum forming;
an injection molding plastic element could be a frame structure corresponding to the periphery of the single plastic panel, or a composite structure made of several strip structures or block structures to corresponding to the periphery of the single plastic panel, which is made by injection molding;
the injection molding plastic element is attached to the periphery of the single plastic panel by ultrasonic welding or gluing.

2. The single-layer plastic composite panel according to claim 1, wherein, furthermore, the injection molding plastic element also has one or several strip structures connected respectively to the edge of the single plastic panel.

3. The single-layer plastic composite panel according to claim 2, wherein the said strip structures connected to the edge of the single plastic panel are laid out in the said frame structure and form a integral structure together with the said frame structure.

4. The single-layer plastic composite panel according to claim 1, wherein a strengthener is inserted between the single plastic panel and the injection molding plastic element, and is completely covered in the space surrounded by the single plastic panel and the injection molding plastic element.

5. The single-layer plastic composite panel according to claim 1, wherein strengthener is embedded in all or part of the junction of the injection molding plastic element which is connected to the single plastic panel and has a groove used for embedding the strengthener.

6. The single-layer plastic composite panel according to claim 1, wherein the colors of the said single plastic panel and the injection molding plastic element could be same or different.

7. The single-layer plastic composite panel according to claim 1, wherein the edges of the said single plastic panel bend downwards and cover the injection molding plastic element, and a rack set up on the outside of the injection molding plastic element is used to support the end plane of the single plastic panel.

8. The single-layer plastic composite panel according to claim 1, wherein integral molding slots in which part or all of the edges of the single plastic panel could insert respectively is set up horizontally or vertically in the injection molding plastic element.

9. The single-layer plastic composite panel according to claim 1, wherein several convex points or strips, which are set up on the end plane of the injection molding plastic element contacting with the plastic single panel, could be melted by ultrasonic welding in order to connect the injection molding plastic element and the plastic single panel together.

10. The single-layer plastic composite panel according to claim 1, wherein an integral molding junction which is bonded to the said injection molding plastic element is used for fixing the injection molding plastic element to the single plastic panel.

11. The single-layer plastic composite panel according to claim 10, wherein the junction of the said injection molding plastic element is a V-shaped component or a component with a hole, and two single-layer plastic composite panels are bonded together with a V-shaped component or a component with a hole.

12. The single-layer plastic composite panel according to claim 1, wherein the top surface of the said single plastic panel also has some printed patterns; the top surface of said single plastic panel comprises a thin film layer having patterns; the top surface of the said single plastic panel has the patterns transfer printed by the transfer printing film layer, and thermal curing varnish or light curing varnish is daubed on the patterns.

13. The single-layer plastic composite panel according to claim 2, wherein a strengthener is inserted between the single plastic panel and the injection molding plastic element, and is completely covered in the space surrounded by the single plastic panel and the injection molding plastic element.

14. The single-layer plastic composite panel according to claim 3, wherein a strengthener is inserted between the single plastic panel and the injection molding plastic element, and is completely covered in the space surrounded by the single plastic panel and the injection molding plastic element.

15. The single-layer plastic composite panel according to claim 2, wherein strengthener is embedded in all or part of the junction of the injection molding plastic element which is connected to the single plastic panel and has a groove used for embedding the strengthener.

16. The single-layer plastic composite panel according to claim 3, wherein strengthener is embedded in all or part of the junction of the injection molding plastic element which is connected to the single plastic panel and has a groove used for embedding the strengthener.
